(19) United States
(12) Patent Application Publication
(10) Pub. No.: US 2014/0136936 A1
(43) Pub. Date: May 15, 2014

(54) SPREADSHEET FUNCTIONS TO CALL REST API SOURCES

(71) Applicant: MICROSOFT CORPORATION, Redmond, WA (US)

(72) Inventors: Keyur Rahul Patel, Seattle, WA (US); Shahar Prish, Tel-Aviv (IL); Shubho Sadhu, Redmond, WA (US); Lee William Bizek, Issaqueh, WA (US); Xiaohui Pan, Sammamish, WA (US)

(73) Assignee: MICROSOFT CORPORATION, Redmond, WA (US)

(21) Appl. No.: 13/672,704

(22) Filed: Nov. 9, 2012

(51) Int. Cl. G06F 17/00

(52) U.S. Cl. 715/212

(57) ABSTRACT

Spreadsheet functions are provided that enable interactivity with web services and manipulation of data retrieved from a web service call. One function takes a URL as an argument and performs an HTTP GET request asynchronously to return the response into the spreadsheet application. Another function URL encodes its argument. The URL encoded argument can then be used as part of the URL of the web service call. Yet another function is a filtering function that takes XML, JSON, HTML, and other forms of data that may be returned via a web service call to obtain specific data such as via an XPath standard when XML is used. These functions may be used together or separately.

### BACKGROUND

Spreadsheet software applications are graphical presentations and tools for organizing and manipulating data. A spreadsheet application enables a user to apply formulas and functions to data entered into rows and columns of cells in a grid. Each cell can hold a piece of data and can be referenced using a column value (such as a letter) and a row value (such as a number) of where the cell is located. In general, a spreadsheet is a rectangular table or grid of information designed to perform general computations tasks using relationships between cells in the grid. Calculations, graphing tools, and filtering can be carried out on the data (or other content) in the cells and the results displayed. Online and mobile functionality have been incorporated into spreadsheet software applications to provide users with portability and additional access.

As web services gain in popularity, being able to harness these sources of information is becoming of interest to many data consumers. It can be desirable to be able to incorporate real time data, such as stock prices and weather statistics, into a spreadsheet so that a user may act upon and organize the real time data using the functionality of a spreadsheet.

### BRIEF SUMMARY

Spreadsheet functions are provided that enable interactivity with web services and manipulation of data retrieved from a web service call. A category of “Web” functions is provided including =WEBSERVICE(url), =FILTERXML(xml, xpath), and =ENCODEURL(text).

WEBSERVICE(url) is used to make an asynchronous web service call, allowing the spreadsheet calculations to continue processing while the request is being processed. Once processed, the result is returned to the spreadsheet application. On entry, the spreadsheet application employs a caching mechanism to cache any previous calls for a short duration to improve performance. Additionally, only a certain number of web requests may be allowed at any given time. However, this limit does not necessarily apply to the number of WEBSERVICE(url) calls in a spreadsheet.

FILTERXML(xml, xpath) takes in an arbitrary valid XML string and uses the XPath notation standard to query and return values from the XML. It can be used with any web services that return data in any XML format and any string in XML format. This function can return one or more values. If multiple values are returned the function can be array entered into the spreadsheet application. Otherwise, existing indexing functions such as INDEX can be used to index into the data. The filtering function allows a user to filter on XML strings based on the xpath argument. The xpath argument can be a standard XPath string, which can be used to return the result(s) from the XML, and is evaluated synchronously.

ENCODEURL(text) encodes specified text and is evaluated synchronously. This function allows the user to use references to other cells allowing the proper encoding to be used as input to the URL parameter in WEBSERVICE function

The functions can also be accessed programmatically, for example, through visual basic for applications (VBA) or C API, which can facilitate the creation of custom solutions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a system diagram illustrating an illustrative operating environment for various embodiments disclosed herein

FIG. 2 shows an example system on which certain embodiments of the invention may be carried out.

FIGS. 3A and 3B illustrate examples involving a representative spreadsheet in which web functions of certain embodiments of the invention are used.

FIG. 4A shows an example spreadsheet for illustrating an application of web functions in accordance with certain embodiments of the invention.

FIGS. 4B and 4C show a process flow for applying web functions in accordance with certain embodiments of the invention.

FIGS. 5A and 5B show an example spreadsheet for illustrating where an output of a web function of an embodiment of the invention is an array.

FIGS. 6A-6C show a process flow utilizing three web functions in accordance with an embodiment of the invention.

FIG. 7 shows an example spreadsheet for illustrating an application of the three web functions in accordance with an embodiment of the invention.

FIG. 8 shows a diagram of a calculation process in accordance with an embodiment of the invention.

FIG. 9 shows a block diagram illustrating components of a computing device used in some embodiments.

### DETAILED DESCRIPTION

Spreadsheet functions are provided that enable interactivity with web services and manipulation of data retrieved from a web service call. A function performs a calculation and returns a value. In accordance with the systems and techniques described herein, a variety of content can be returned from a source to the spreadsheet application. In addition, a function is provided that can be used as part of a spreadsheet model, enabling encoding of parameters to the REST call.

Embodiments facilitate the retrieval of live web data from a publicly available web service without a user having to create custom code. According to certain embodiments of the invention, REST end points can be queried using the HTTP protocol through a built-in asynchronous worksheet function, reducing the need for customer developer code.

In addition, various embodiments of the invention provide this functionality without placing a cap on the number of calls to the publicly available web services that can be made in one workbook of a spreadsheet application. Certain embodiments of the invention include security related aspects which inhibit the Web functions of various embodiments of the invention from causing denial of service (DoS) attacks by the spreadsheet application while not placing a strict limit on the number of calls that can be made in a spreadsheet. For example, while only a certain number of web requests may be allowed at any given time, this limit does not necessarily apply to the number of WEBSERVICE(url) calls in a spreadsheet.

According to certain embodiments, the control of the number of web service requests can be accomplished through caching and throttling. For caching, when a web service call is performed via the WEBSERVICE(url) function, the response may be stored locally in a cache for a period of time. For example, in a WEBSERVICE call to a Wikipedia API, a first call may successfully return a response. At this time, a value is provided in a corresponding cell (and stored in a cache locally). If, within a predetermined time period (for example, 2-60 seconds), another WEBSERVICE(url) call is made to the same URL, it is conceivable—and in this case expected—that a same result would be returned again. For this type of situation, WEBSERVICE does not make a web request and instead accesses the cache and returns the cached value.

For throttling, the number of active HTTP calls that can be made at a given time is limited. For example, an unbounded number of WEBSERVICE calls may be allowed in the spreadsheet, but only a certain number of HTTP requests are made active at a given time. This is similar to the traffic lights on freeway on-ramps during rush hour; a certain number of cars are allowed to pass in a certain time, but eventually each car waiting to enter the freeway will get through.

A workbook is a spreadsheet file that generally contains at least one worksheet. The worksheets in a workbook each present a grid of cells that can reference cells in a same worksheet or in another worksheet of the workbook.

Examples of spreadsheet applications include MICROSOFT EXCEL, which may be proved as a standalone application or as part of an application suite such as MICROSOFT OFFICE or MICROSOFT WEB APPS and OFFICE365, trademarks and registered trademarks of Microsoft Corp., the spreadsheets of the GOOGLE DOCS program, a trademark of Google Inc., and APPLE NUMBERS, a registered trademark of Apple Inc.

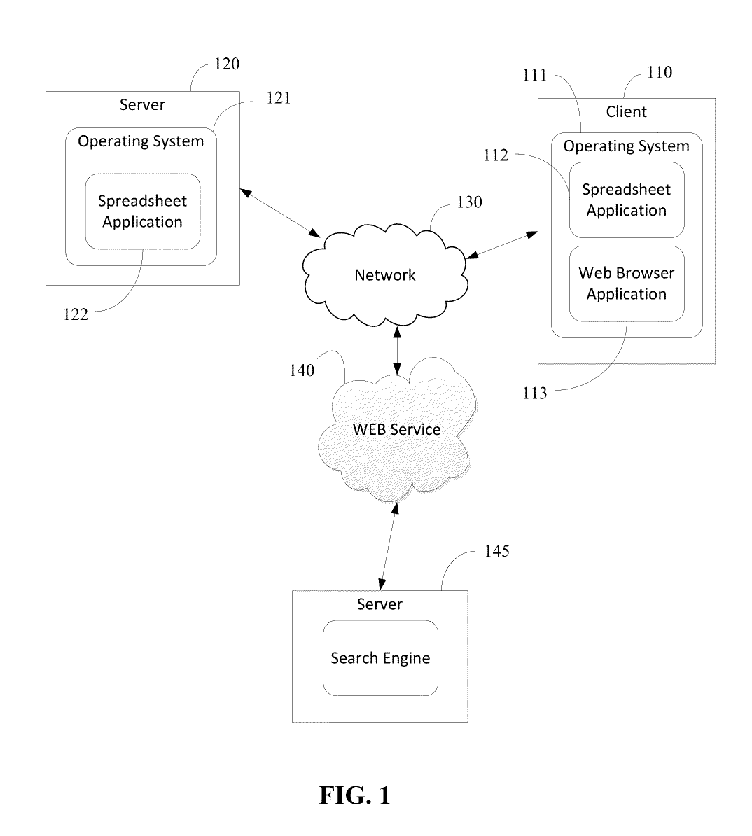

FIG. 1 shows an operating environment in accordance with an embodiment of the invention. Referring to FIG. 1, a client 110 and a server 120 communicate via a network 130. A web service 140 may be implemented between client 110 and server 120 as well as between client 110 and one or more other servers (for example, search engine server 145) or between server 120 and one or more other servers (for example, search engine server 145).

Communication between computing devices in a client-server relationship may be initiated by a client sending a request to the server asking for access to a particular resource or for particular work to be performed. The server may subsequently perform the actions requested and send a response back to the client.

An application programming interface (API) may be incorporated to provide a software-to-software interface that enables applications to communicate over the network 130.

An API is generally a set of programming instructions and standards for enabling two or more applications to communicate with each other and is commonly implemented as a set of Hypertext Transfer Protocol (HTTP) request messages and a specified format or structure for response messages. The messages can contain an information resource. A resource is information that can be identified by a uniform resource identifier (URI) and may be a file, a dynamically-generated query result, the output of a common gateway interface (CGI) script, a document that is available in several languages, and the like.

Common formats for the messages include Extensible Markup Language (XML) and JavaScript Object Notation (JSON) formats. The requests and responses (e.g., the calls back and forth between applications) according to an API can be managed through web services.

One type of API is a web service. A web service is a software system that supports interoperable machine-to-machine interaction over a network and enables software to connect to other software applications. A web service provides a collection of technological standards and protocols. The web service provides functions that may be implemented by a software or hardware agent that sends and receives messages (e.g., the computing platforms requesting and providing a particular service). Web Services are readily available sources of information across the web today. Major web sites offer Representational state transfer (REST) compliant web services as part of their public API offerings.

REST refers to a web architecture that governs the behavior between clients and servers of a distributed system such as the Web. In general, a RESTful web service presents a uniform interface between clients and servers and may be implemented using, for example, HTTP, XML, and JSON. Instead of requiring a well-defined message to a particular resource, REST may simply request a specific resource.

Although web service 140 and network 130 are illustrated as separate entities in FIG. 1, it should be understood that the distinction is merely to emphasize the web service application. The web service may be implemented using one or more physical and/or virtual servers communicating over network 130. Applications running on client 110 and server 120 can access web services via ubiquitous Web protocols and data formats such as HTTP, XML, JSON and SOAP.

In accordance with certain embodiments of the invention, the network 130 may be an internet, an intranet, or an extranet, and can be any suitable communications network including, but not limited to, a cellular (e.g., wireless phone) network, the Internet, a local area network (LAN), a wide area network (WAN), a WiFi network, an ad-hoc network, or a combination thereof. Such networks may involve connections of network elements, such as hubs, bridges, routers, switches, servers, and gateways.

The network 130 may include one or more connected networks (e.g., a multi-network environment) including public networks, such as the Internet, and/or private networks such as a secure enterprise private network. Access to the network 130 may be provided via one or more wired or wireless access networks (not shown), as will be understood by those skilled in the art. As will also be appreciated by those skilled in the art, communication networks can take several different forms and can use several different communication protocols.

The client 110 and the server 120 can involve computing systems configured with one or more central processing units (CPUs), memory, mass storage, and I/O devices (e.g., network interface, user input device). Elements of the computing system can communicate with each other via a bus. The hardware platform of computing systems can be embodied in many forms, including, but not limited to, a personal computer, a server computer, a hand-held or laptop device, a multiprocessor system, a microprocessor-based system, programmable consumer electronics, and a distributed computing environment that includes any of the above systems or devices.

In certain embodiments, the client 110 can be embodied as a computing device including, but not limited to, a personal computer, a tablet, a mobile device, a personal digital assistant (PDA), a smartphone, a laptop (or notebook or netbook) computer, a gaming device or console, a desktop computer, or a smart television.

In certain embodiments, the server 120 can be embodied as a computing device including, but not limited to, a server computer, an enterprise computer, a personal computer, a multiprocessor system, a microprocessor-based system, and a combination thereof. It should be understood that the listing of client computing devices and the server computing devices is not intended to be limiting and that the client and server may be embodied in the same or different form.

The client computing device 110 is configured to execute an operating system 111 and one or more application programs such as, in the illustrated embodiment, a spreadsheet application 112, a web browser application 113, and/or one or more other applications.

The operating system 111 is a computer program for controlling the operation of the client computing device 110. The application programs are executable programs configured to execute on top of the operating system 111 to provide various functionality such as described herein. The spreadsheet application 112 is an application program configured to receive and display data in cells in a simulated worksheet of rows and columns. One or more formulas can be applied to all or a portion of the data to perform calculations, filtering, and other analysis. The data can alternatively or additionally be used as the basis for creating tables, charts, sparklines (a simplified line chart), and other visualizations.

The web browser application 113 is an application program for retrieving and traversing information resources on the World Wide Web (“the Web”), as well as resources provided by web servers in private networks via the network 130, and presenting the information resources to a user (e.g., rendering for display). Moreover, the web browser application 113 allows a user to access information and various functions provided by a server.

The illustrated server computer 120 is configured to execute a server operating system 121, one or more application programs such as a server spreadsheet application 122, and/or one or more other applications.

The server operating system 121 is a computer program for controlling the operation of the server computing device 120, and the application programs are executable programs configured to execute on top of the server operating system 121 to provide various functionality described herein. The server spreadsheet application 122, in some embodiments, is a web-based application program configured to receive and display data in cells in a spreadsheet document such as a worksheet. In some embodiments, the server computer 120 is configured to execute the server spreadsheet application 122 and the client computing device 110 is configured to access the server computer 120 to interact with the server spreadsheet application 122 in a client/server configuration. In these embodiments, the server spreadsheet application 122 may provide functionality that is identical to the spreadsheet application 112.

In one embodiment, the client web browser application 113 is used to connect with a server, for example, server computing device 120, in order to access a web-based spreadsheet application 122.

It should be understood that multiple client computing devices, multiple networks, and/or multiple servers may be included as part of the operating environment.

Embodiments facilitate the use of web content in spreadsheet applications through the use of functions that get web content and convert the web content into usable data. Instead of requiring custom coding for a user to get live web data from a publicly available web service, embodiments provide web service functions from within a spreadsheet application. This enables a user to bring live web data into the spreadsheet application where the data can be manipulated and displayed using the tools available within the spreadsheet application.

Currently, a user would utilize a macro to create code in visual basic for applications (VBA) for a specific function. VBA is a software tool for creating macros, procedures and custom functions that may be used in spreadsheet applications such as MICROSOFT EXCEL. Certain spreadsheet applications support user functions created in VBA. However, crafting custom VBA functions may be time-consuming and non-trivial. Embodiments of the invention can enable a developer to skip the programming steps and use a function within the spreadsheet program. As an alternative to VBA, users may also utilize a C API (a C or C++ programming interface).

For example, through VBA or a C API, a VBA macro may be created that uses WEBSERVICE programmatically to get weather data from a Web service, processes the data, and inserts the results in the spreadsheet.

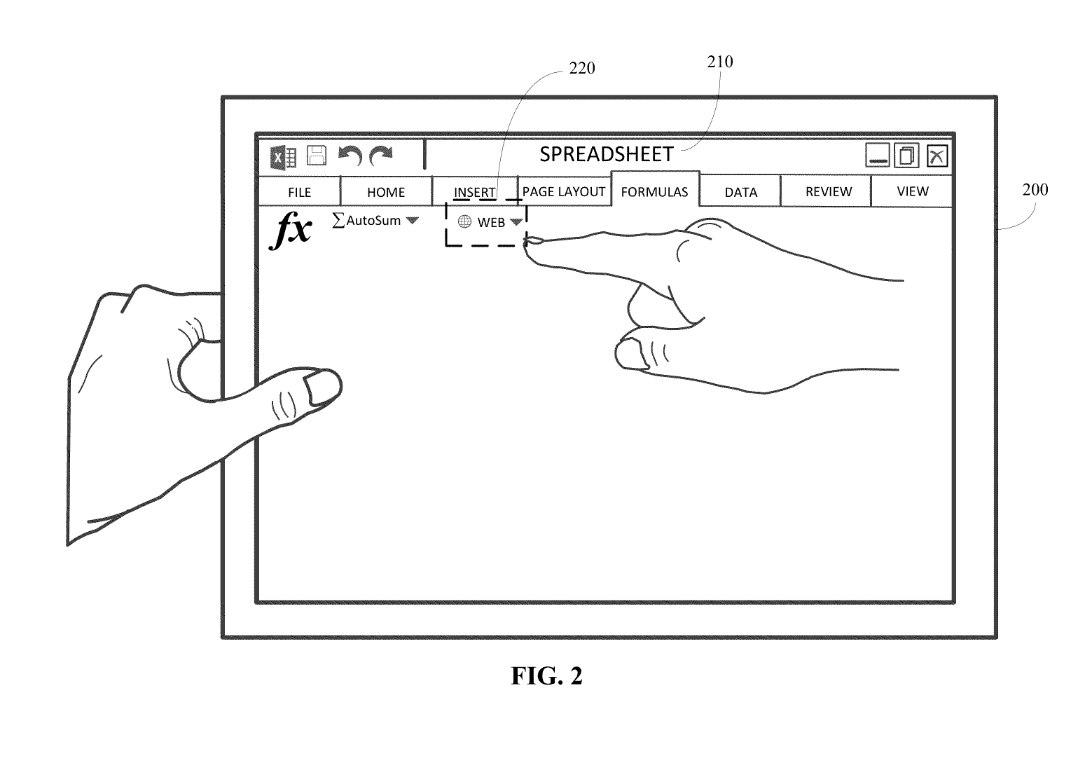

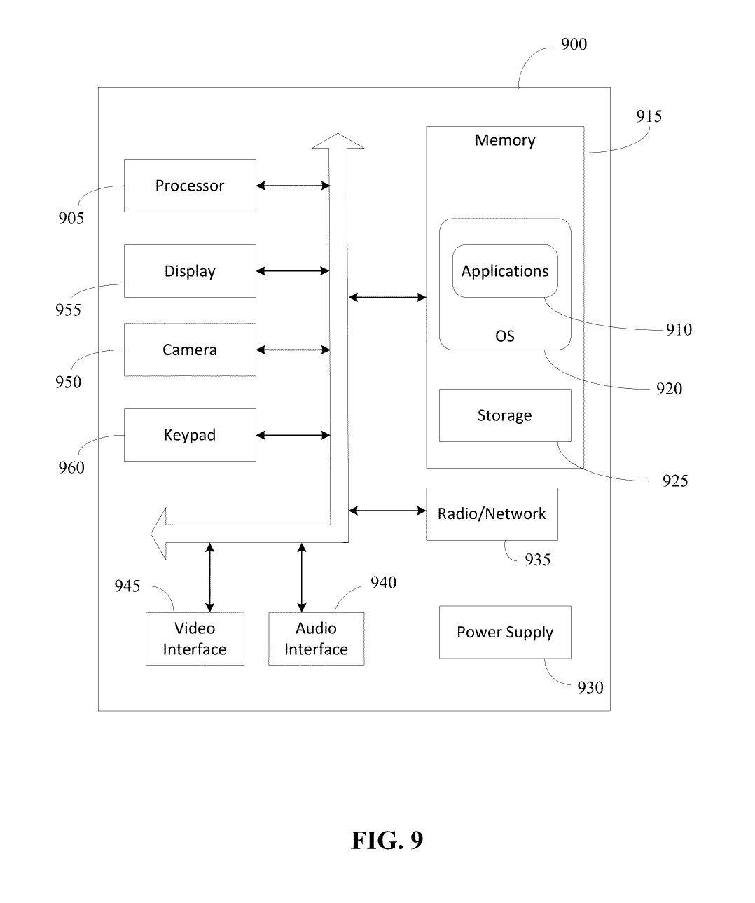

FIG. 2 shows an example system on which certain embodiments of the invention may be carried out. Referring to FIG. 2, a client computing device, such as a tablet 200 can display a spreadsheet application 210 that may be a spreadsheet application running on the device 200 or a spreadsheet application running on a server and accessed through a web browser application running on the device 200. In one embodiment, a user may access a web function 220 from a menu, drop-down box, or ribbon. The computing device 200 can include components as described with respect to FIG. 9.

The web function 220 can include functions that bring data from REST API sources as well as functions that filter the data received from the REST API sources and encode data for use in calling REST API sources. Of course, it should be understood that embodiments are not limited to interactions with REST API sources, and data received through any suitable source (including user manual input) may be filtered and encoded using web functions described herein.

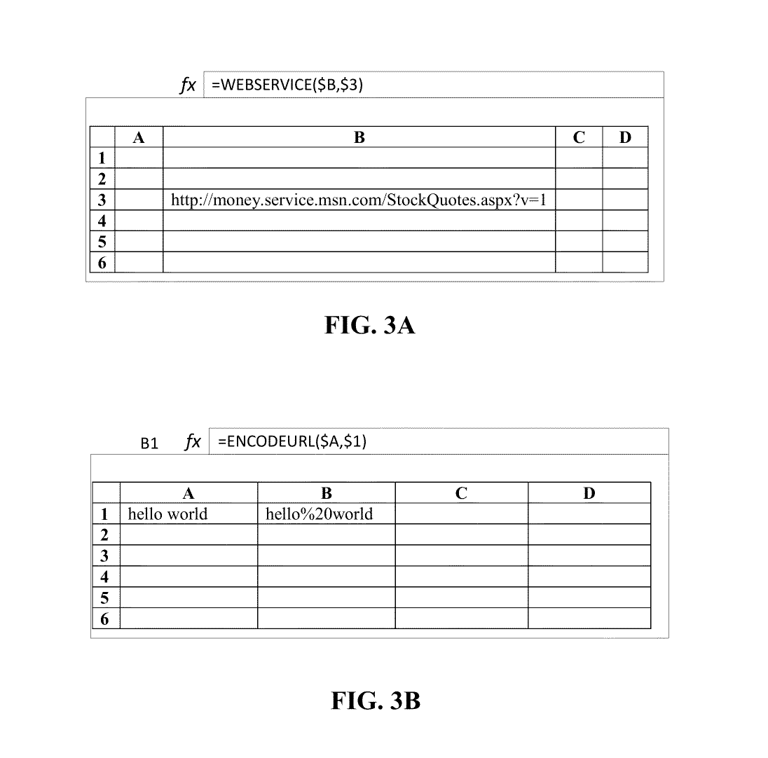

In accordance with one embodiment of the invention, a web function =WEBSERVICE(url) is provided that returns data from a web service given the uniform resource locator (URL) of the web service. For example, referring to FIG. 3A, the function =WEBSERVICE($B$3) can take the string at cell B3, which contains the URL “http://money.service.msn.com/StockQuotes.aspx?v=1”, as its argument. The function makes an asynchronous web service call, allowing the spreadsheet calculations to continue processing while the request is being processed. Once processed, the result is returned to the spreadsheet application where the application can finish calculation of any formulas that depend on the web service function. On entry, the spreadsheet application employs a caching mechanism to cache any previous calls for a short duration to improve performance.

In operation, the function asynchronously calls the web service located at the URL by using an HTTP GET request and returns the response.

The GET request retrieves the information identified by the request URI—the URL in this embodiment. If the request URI refers to a data-producing process, it is the produced data that is returned as the entity in the response and not the source text of the process, unless that text happens to be the output of the process.

In accordance with another embodiment of the invention, a web function =ENCODEURL(text) is provided that returns a URL encoded string given text. The function encodes the argument text into a form that is appropriate for a site to which a web service request may be made. In a further embodiment, the =ENCODEURL(text) may be applied to a cell in the spreadsheet and the =WEBSERVICE(url) function may refer to the cell that is URL encoded for its argument.

In some embodiments, the =ENCODEURL(text) function can prepend certain characters (such as “?”) and/or insert other characters (such as “&”) between each key-value pair as specified in the URL encoding general syntax rules provided, for example, by the Internet Engineering Task Force (IETF). Of course, embodiments are not limited thereto and the prepending and/or insertion of certain characters may be omitted. As an example, =ENCODEURL($A$1), such as shown in FIG. 3B, where cell A1 contains the string “hello world” would return “hello%20world” (shown in cell B1).

In accordance with yet another embodiment of the invention, a web function =FILTERXML(xml,xpath) (or alternatively, a hypertext markup language (HTML) or JSON filter) is provided that gets specific data from an XML string in the spreadsheet. The XML string may be the returned XML string from a WEBSERVICE function call. In addition to filtering data received from the REST API sources, the FILTERXML function can be used to filter any XML string within the spreadsheet application.

The function takes a string in valid XML format (or HTML or JSON if those are the ones used) and a string in standard XPath format. The XPath parameter can be used to search for attributes of the data and obtain a corresponding value of the attribute. If the XML uses a default namespace, an xldefault prefix may be used to reference that element. The XPath parameter is used to filter the XML string to return one or more results. If multiple values are returned, the function can be an array entered into the spreadsheet application. Otherwise, existing indexing functions such as INDEX can be used to index into the data. Indexing can be performed using an index function or by using a querying language's syntax (e.g., the syntax available through Xpath). For example, a user may obtain the kth element of the returned values through a query using Xpath.

The XPath parameter is based off the XPath standard such as described by W3C, a registered trademark of the World Wide Web Consortium; marks of W3C are registered and held by its host institutions MIT, ERCIM, and Keio. In one embodiment, the XPath parameter can handle 1024 characters. In other embodiments, the Xpath parameter may be limited only by the available characters to the spreadsheet application. For example, a current version of Excel may limit XPath to 32768 characters. Of course, these numbers should not be construed as limiting the available characters of various implementations.

A greater understanding of the present invention and of its many advantages may be had from the following examples, given by way of illustration. The following examples are illustrative of some of the methods, applications, embodiments and variants of the present invention. They are, of course, not to be considered in any way limitative of the invention. Numerous changes and modifications can be made with respect to the invention.

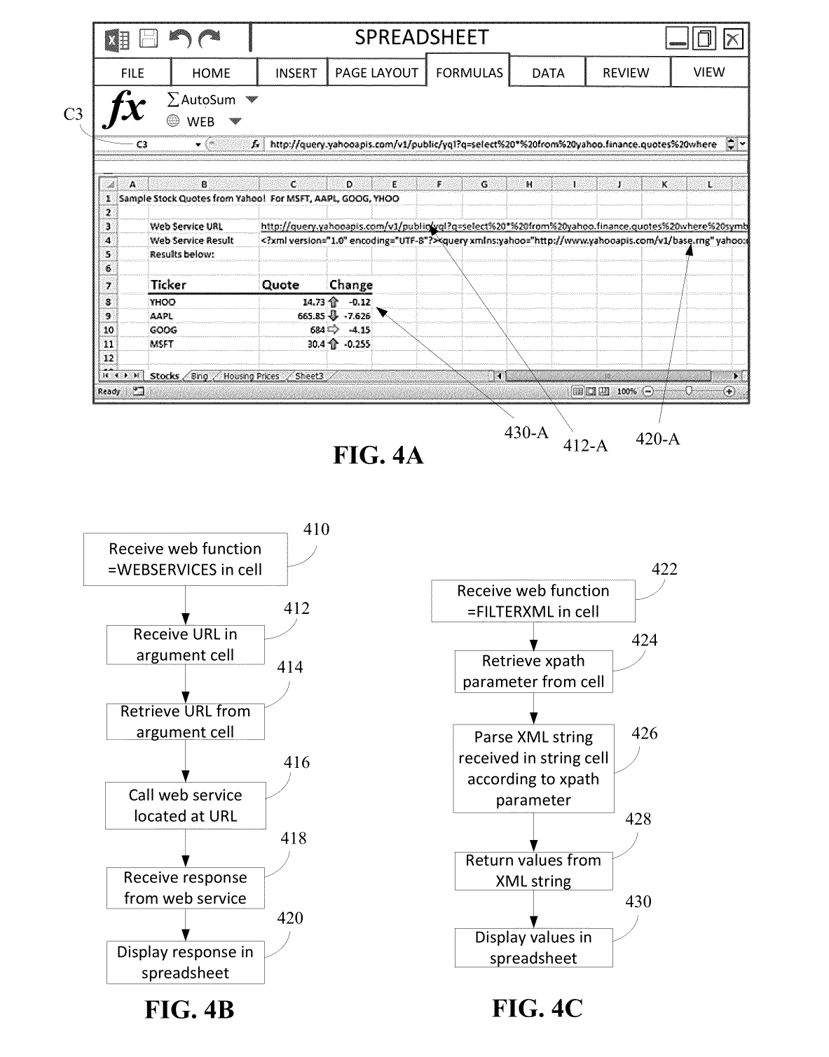

FIG. 4A shows an example spreadsheet for illustrating an application of web functions in accordance with certain embodiments of the invention; and FIGS. 4B and 4C show a process flow for applying web functions in accordance with certain embodiments of the invention.

In the example of FIG. 4A, a web function of an embodiment of the invention can be used in place of a custom function created in VBA for getting stock quotes. In particular, the example uses the WEBSERVICE function and the FILTERXML function to create a table with current stock quotes. As shown in FIG. 4B, the web function WEBSERVICE can be received by the spreadsheet application (410). It should be understood that in some cases, the function is provided as part of a template or worksheet in a manner that each call to the function may not require re-applying or re-entering the function into the spreadsheet application. The argument for the WEBSERVICE function is a URL, which is also received in a cell of the spreadsheet application (412). For example, cell C3 shown in FIG. 4A can contain the URL 412-A for the web service being called. In this case, the web service is from Yahoo! in order to retrieve stock quotes for Microsoft Corp. (MSFT), Apple Inc. (AAPL), Google Inc. (GOOG), and Yahoo! Inc. (YHOO).

The URL in the argument cell C3 is retrieved by the spreadsheet application (414) as part of the spreadsheet calculations and the web service located at the URL is called (416). The argument for the WEBSERVICE function may be entered by a user directly within the function or in a cell that is referenced by the function.

Because the call (416) to the web service located at the URL is performed asynchronously, other calculations may be carried out while waiting for the results to be received.

Instead of filtering the data from the web service before providing to the spreadsheet, certain embodiments of the invention enable manipulation of the unfiltered data from within the spreadsheet.

For example, when the response from the web service is received (418), the response can be displayed in the spreadsheet (420). For example, as shown in FIG. 4A, an XML string 420-A can be received and displayed in a cell.

Once the XML string 420-A is within the spreadsheet application, the data can be filtered to obtain the desired information and manipulated using the tools available in the spreadsheet. For example, as one of the available web functions, a FILTERXML can be applied to the XML string received as the web service result. The FILTERXML function can be received in a cell (422) along with the arguments of XPath and the XML string (directly or by reference). For example, the FILTERXML function can pass in cell $C$4 to obtain the XML string along with “//quote/@symbol” for the XPath in the ticker column, “//Ask” for the XPath in the quote column, and “//Change” for the XPath in the change column. The values from the filtering are returned by the function (428) and displayed (430) in the appropriate cells (see element 430-A in FIG. 4A).

Although the web service result is shown as an XML string, embodiments are not limited to XML. For example, JSON, HTML, and even images may be returned.

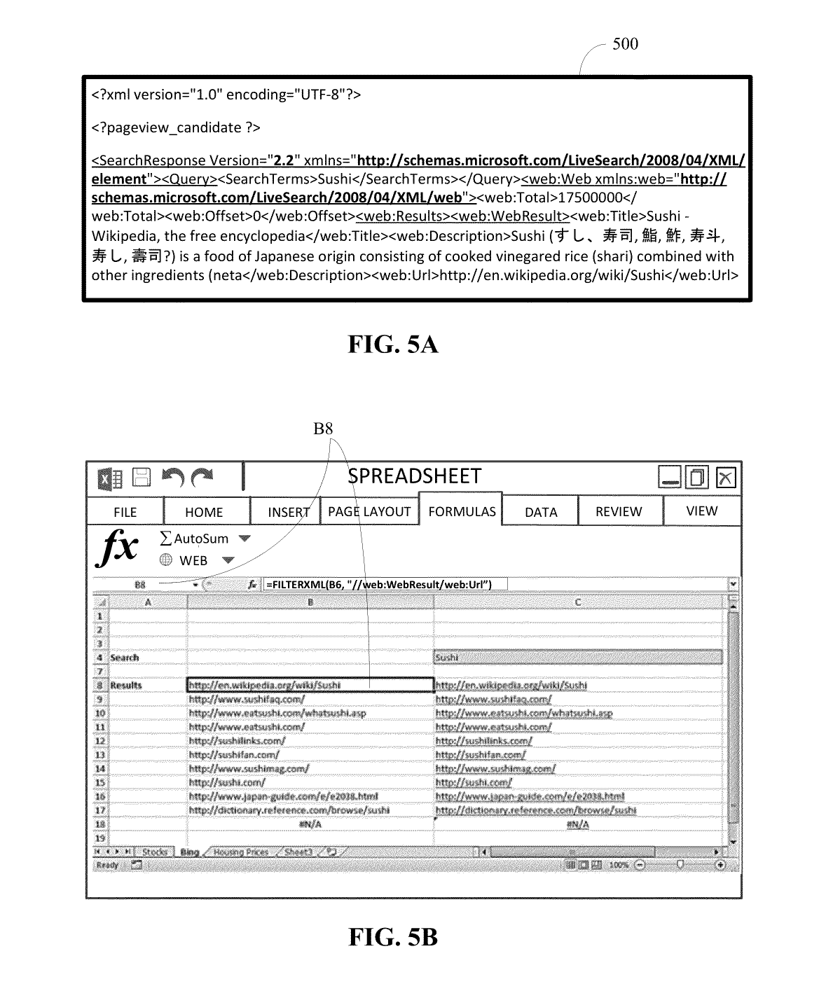

FIGS. 5A and 5B show an example spreadsheet for illustrating where an output of a web function of an embodiment of the invention is an array. FIG. 5A shows a cell 500 containing XML returned from a WEBSERVICE function calling http://schemas.microsoft.com/LiveSearch using “sushi” as a search term (by passing the query through the web service call). FIG. 5B shows a representative screenshot of an array of URL elements obtained by applying the FILTERXML function. For example, with an XPath of “/xldefault:SearchResponse/web:Web/web:Results/web:WebResult/web:URL,” the web:URL elements are returned as an array. One of the cells, B8, is shown with XPath “/web:WebResult/web:URL”.

In accordance with an embodiment, if the formula containing the function is entered as a regular formula, the result (e.g., the first result) is returned. For example, if there is a single result, the result is copied into all destination cells. If the formula containing the function is array entered, then existing array formula behavior can be followed and the result copied in the spreadsheet application. For example, multiple results can be provided as a one-dimensional array in the spreadsheet application when the XPath evaluates to multiple results. The results can be entered into the destination cells following row major order. The type of the result can be parsed based on a parsing engine of the spreadsheet application.

Although the web service result is shown as an XML string, embodiments are not limited to XML. For example, JSON, HTML, and even images may be returned.

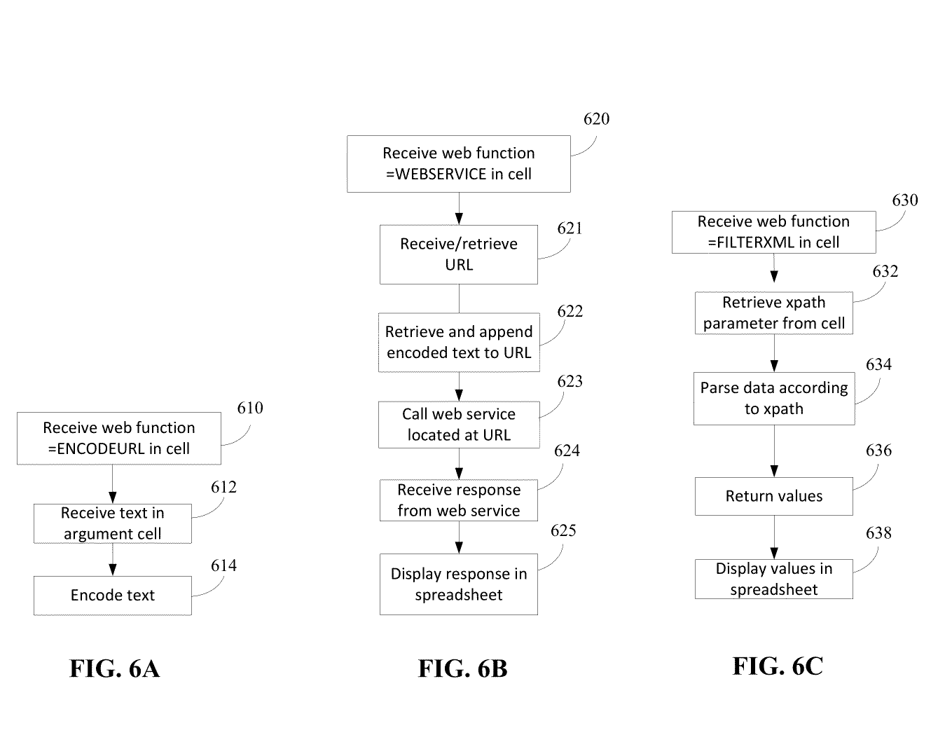

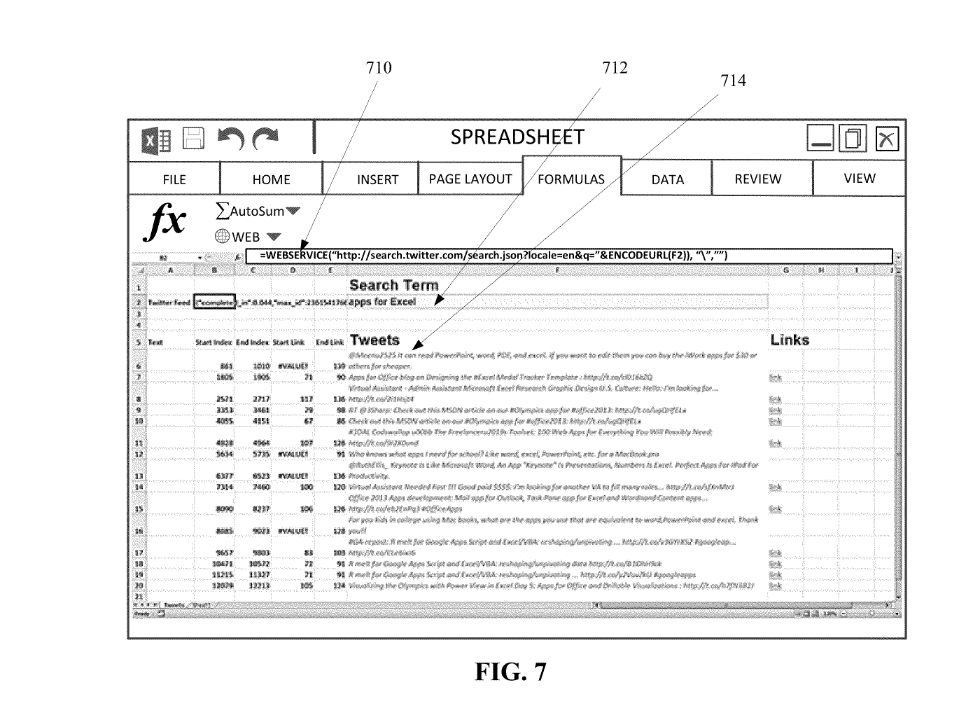

FIGS. 6A-6C show a process flow utilizing three web functions in accordance with an embodiment of the invention; and FIG. 7 shows an example spreadsheet for illustrating an application of the three web functions in accordance with an embodiment of the invention.

In the example of FIG. 7, web functions of embodiments of the invention are used to create a custom solution in which a user of the sheet may perform a search from inside the spreadsheet application and have the results returned into the spreadsheet.

As shown in FIG. 7, a search term 712 can be entered into a cell of the spreadsheet. An ENCODEURL function referencing the cell in which a user enters the search term 712 can be used to encode the natural language search term into a form recognizable by a search engine web service. For example, referring to FIG. 6A, the ENCODEURL function can be received in a cell of the spreadsheet application (610). The ENCODEURL does not need to be re-entered for each use of the function if saved in a cell.

When text is entered into the cell referenced by the ENCODEURL function (612), the ENCODEURL function encodes the text (614) into a form recognizable by the web service. For example, spaces between words may be removed or replaced with certain characters.

For the example illustrated in FIG. 7, a URL having an appended query is used as the argument for a WEBSERVICE function (see element 710 in FIG. 7, which enables TWITTER to be searched for tweets related to apps for EXCEL).

Here, the ENCODEURL is used to enable a natural language query to be entered into a cell of the spreadsheet, converted into web service-recognizable form, and appended to a URL to be used as part of a query. As shown in FIG. 6B, with a WEBSERVICE function received by the spreadsheet application (620) and taking a URL as an argument (for example, through referencing separate cells and appending the encoded text to the URL 621, 622), the web service resource at the URL is called (623). The argument for the WEBSERVICE function may be entered by a user directly within the function or in a cell that is referenced by the function. According to an embodiment, text in a cell can be encoded (e.g., such as shown in FIG. 6A) and the encoded text appended to a URL (622). Then, the URL with appended encoded text can be used as the URL for the WEBSERVICE function argument in order to pass through a search query or other element to the web service. The WEBSERVICE function calls the web service located and the URL (623) and receives a response from the web service (624).

Because the call (623) to the web service located at the URL is performed asynchronously, other calculations may be carried out while waiting for the results to be received.

Instead of filtering the data from the web service before providing to the spreadsheet, certain embodiments of the invention enable manipulation of the unfiltered data from within the spreadsheet.

For example, when the response from the web service is received (624), the response can be displayed in the spreadsheet (625). Of course, the cell in which the response is provided can be made hidden to a user.

Once the data is within the spreadsheet application, the data can be filtered to obtain the desired information and manipulated using the tools available in the spreadsheet. For example, as one of the available web functions, a FILTERXML can be applied to an XML (or, for example, JSON) string that may be received as the web service result. For example, as shown in FIG. 6C, a FILTERXML function can be received in a cell (630) along with the arguments of XPath (632) and the data string (directly or by reference). The XPath can be used to parse the data (634) and the values from the filtering are returned by the function (636) and displayed (638), for example, in a list 714 as shown in FIG. 7.

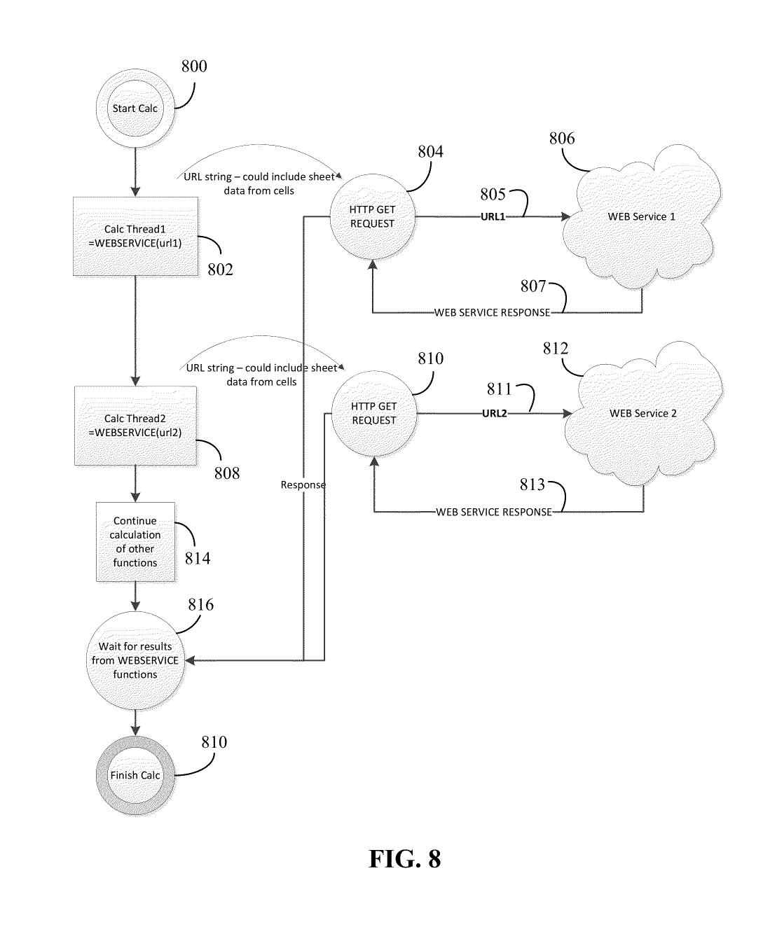

FIG. 8 shows a diagram illustrating a web service function calculation in accordance with an embodiment of the invention. Referring to FIG. 8, multiple web service requests can be initiated. Web service functions can be implemented as built in thread-safe, asynchronous user defined functions on both client/server. A first call using the WEBSERVICE function instantiates an HTTP GET request using the URL string of the cell providing the argument for the web function (and even sheet data from other cells). The HTTP GET request interfaces with the web service at the URL and receives a response from the web service. The spreadsheet system waits for the results from the web service. Because the requests are made asynchronously, multiple requests and main thread formula calculations can be initiated while the spreadsheet application is waiting for results.

For example, a calculation process can begin 800 to calculate a first thread =WEBSERVICE(url1) (802). Url1 is a first URL string and can include sheet data from cells. The web function WEBSERVICE initiates an HTTP GET request (804). The HTTP GET request retrieves whatever information (in the form of an entity) is identified by the Request-URI url1 805. If the Request-URI refers to a data-producing process, it is the produced data that is returned from the web service 1 806 as the entity in the response 807 and not the source text of the process, unless that text happens to be the output of the process.

A second thread can be calculated =WEBSERVICE(url2) (808). Url2 is a second URL string and can include sheet data from cells. The web function WEBSERVICE initiates an HTTP GET request (800). The HTTP GET request retrieves whatever information (in the form of an entity) is identified by the Request-URI url2 811. If the Request-URI refers to a data-producing process, it is the produced data that is returned from the web service 2 812 as the entity in the response 813 and not the source text of the process, unless that text happens to be the output of the process.

Other functions may be calculated 814 as part of the calculation process while waiting for the results 807, 813 from the WEBSERVICE functions. Once the results are received, the calculations can be finished 810. Once the calculations are complete, the data can be displayed.

The URL (and web service) may be the same or different for the web functions. In addition, although FIG. 8 shows two web service calls, embodiments are not limited thereto.

FIG. 9 shows a block diagram illustrating components of a computing device used in some embodiments. For example, system 900 can be used in implementing a desktop or notebook computer or a tablet or smart phone that can run one or more applications similar to those of a desktop or notebook computer such as, for example, browser, e-mail, scheduling, instant messaging, and media player applications. In some embodiments, system 900 is an integrated computing device, such as an integrated personal digital assistant (PDA) and wireless phone.

System 900 includes a processor 905 that processes data according to instructions of one or more application programs 910, including a spreadsheet application, and/or operating system 920. The one or more application programs 910 may be loaded into memory 915 and run on or in association with the operating system 920. Examples of application programs include the spreadsheet application, phone dialer programs, web conferencing programs, e-mail programs, personal information management (PIM) programs, word processing programs, spreadsheet programs, Internet browser programs, messaging programs, game programs, and the like. Other applications may be loaded into memory 915 and run on the device, including various client and server applications.

System 900 also includes non-volatile storage 925 within memory 915. Non-volatile storage 925 may be used to store persistent information that should not be lost if system 900 is powered down. Application programs 910 may use and store information in non-volatile storage 925, such as e-mail or other messages used by an e-mail application, and the like. A synchronization application may also be included and reside as part of the application programs 910 for interacting with a corresponding synchronization application on a host computer system (such as a server) to keep the information stored in non-volatile storage 925 synchronized with corresponding information stored at the host computer system.

System 900 has a power supply 930, which may be implemented as one or more batteries and/or an energy harvester (ambient-radiation, photovoltaic, piezoelectric, thermoelectric, electrostatic, and the like). Power supply 930 might further include an external power source, such as an AC adapter or a powered docking cradle that supplements or recharges the batteries.

System 900 may also include a radio/network interface 935 that performs the function of transmitting and receiving radio frequency communications. The radio/network interface 935 facilitates wireless connectivity between system 900 and the “outside world,” via a communications carrier or service provider. Transmissions to and from the radio/network interface 935 are conducted under control of the operating system 920, which disseminates communications received by the radio/network interface 935 to application programs 910 and vice versa.

The radio/network interface 935 allows system 900 to communicate with other computing devices, such as over a network.

An audio interface 940 can be used to provide audible signals to and receive audible signals from the user. For example, the audio interface 940 can be coupled to a speaker to provide audible output and a microphone to receive audible input, such as to facilitate a telephone conversation. System 900 may further include video interface 945 that enables an operation of an optional camera (950) to record still images, video stream, and the like. Visual output can be provided via a touch screen display 955. In some cases, the display may not be touch screen and a user input elements, such as buttons, keys, roller wheel, and the like, are used to select items displayed as part of a graphical user interface on the display 955. A keypad 960 can also be included for user input. The keypad 960 may be a physical keypad or a soft keypad generated on the touch screen display 955.

It should be understood the any mobile or desktop computing device implementing system 900 may have additional features or functionality and is not limited to the configurations described herein.

In various implementations, data/information stored via the system 900 may include data caches stored locally on the device or the data may be stored on any number of storage media that may be accessed by the device via the radio/network interface 935 or via a wired connection between the device and a separate computing device associated with the device, for example, a server computer in a distributed computing network, such as the Internet. As should be appreciated such data/information may be accessed through the device via the radio 935 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Computer-readable media can be any available computer-readable storage media or communication media that can be accessed by the computer system. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

It should be appreciated by those skilled in the art that computer-readable storage media include removable and non-removable structures/devices that can be used for storage of information, such as computer-readable instructions, data structures, program modules, and other data used by a computing system/environment. A computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. Computer-readable storage media should not be construed or interpreted to include any carrier waves or propagating signals.

Furthermore, in addition to being implemented as software, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A computer-readable storage medium having stored thereon instructions that, when executed, perform a method comprising:
requesting data from a service provider accessed via a URL entered from a spreadsheet; and
receiving data returned by the service provider.

2. The medium of claim 1, wherein receiving the data returned by the service provider comprises:
receiving an Extensible Markup Language (XML) string into the spreadsheet.

3. The medium of claim 1, wherein receiving the data returned by the service provider comprises:
receiving a JavaScript Object Notation (JSON) string into the spreadsheet.

4. The medium of claim 1, wherein receiving the data returned by the service provider comprises:
receiving a hypertext markup language (HTML) string into the spreadsheet.

5. The medium of claim 1, wherein the URL is provided in a cell of the spreadsheet and referenced by a web function of a spreadsheet application, the web function asynchronously requesting the data from the service provider accessed via the URL.

6. The medium of claim 1, wherein the URL entered from a spreadsheet comprises URL encoded text received in a cell of the spreadsheet.

7. The medium of claim 1, wherein the method further comprises:
receiving a first URL as the URL;
performing worksheet calculations comprising:
calculating a first web function comprising requesting data from a first service provider accessed via the first URL;
calculating a second web function comprising requesting data from a second service provider accessed via a second URL entered from the spreadsheet;
receiving results from first web function; and
calculating a third web function comprising filtering the results from the first web function to return a filtered result; and
displaying the results from the first web function and the filtered result in the spreadsheet.

8. A computer-readable storage medium having stored thereon instructions that, when executed, perform a method comprising:
querying a markup language string in a spreadsheet for one or more elements; and
extracting one or more values corresponding to the one or more elements from the markup language string.

9. The medium of claim 8, wherein the one or more elements comprise at least one attribute of the data.

10. The medium of claim 8, wherein the querying comprises using an XPath notation standard to query the markup language string.

11. The medium of claim 8, wherein the markup language comprises XML.

12. The medium of claim 8, wherein the markup language comprises JSON.

13. The medium of claim 8, wherein the markup language comprises HTML.

14. The medium of claim 8, wherein the extracting of the one or more values comprises extracting a plurality of values, the method further comprising entering an array of the plurality of values into the spreadsheet.

15. The medium of claim 8, further comprising applying an index function or query to index the extracted one or more values.

16. The medium of claim 8, wherein the markup language string is in a cell referenced by a web function of a spreadsheet application, the web function comprising the querying of the markup language string in the spreadsheet and the extracting of the one or more values.

17. The medium of claim 8, wherein the markup language string comprises data returned by a service provider after requesting the data from the service provider accessed via a URL entered into a cell of the spreadsheet.

18. A computer-readable storage medium having stored thereon instructions that, when executed, perform a method comprising:
encoding text received in a cell of a spreadsheet into a URL compatible format.

19. The medium of claim 18, wherein the method further comprises:
requesting data from a service provider accessed via a URL comprising the encoded text; and
receiving data returned by the service provider.

20. The medium of claim 18, wherein the cell is referenced by a web function of a spreadsheet application, the web function encoding the text in the cell into the URL compatible format.
